(19) United States
(12) Patent Application Publication
(10) Pub. No.: US 2023/0278694 A1
(43) Pub. Date: Sep. 7, 2023

(54) METHOD OF UTILIZING AN ELECTRIC AIRCRAFT BATTERY BAY FOR PAYLOAD STORAGE

(71) Applicant: BETA AIR, LLC, SOUTH BURLINGTON, VT (US)

(72) Inventor: Alexander Hoekje List, SOUTH BURLINGTON, VT (US)

(73) Assignee: BETA AIR, LLC, SOUTH BURLINGTON, VT (US)

(21) Appl. No.: 17/688,361

(22) Filed: Mar. 7, 2022

(51) Int. Cl. B64C 1/22; H01M 50/262; H01M 50/249; B64D 27/24; B64C 1/06; B64D 9/00; B64C 29/00

(52) U.S. Cl. CPC B64C 1/22; H01M 50/262; H01M 50/249; B64D 27/24; B64C 1/061; B64D 9/003; B64C 29/0025; H01M 2220/20; H01M 50/269

(57) ABSTRACT

Described in this disclosure are methods of removing one or more battery packs from a battery bay of an electric aircraft so that a payload may be stored within the battery bay of the electric aircraft. The battery bay may be disposed within a fuselage of the electric aircraft. The payload may be loaded into the battery bay using a loading mechanism, such as a conveyor belt. Furthermore, the payload may be secured within the battery bay relative to the electric aircraft by, for example, a fastener.

### FIELD OF INVENTION

The present invention generally relates to the field of aircraft. In particular, the present invention is directed to a method of utilizing an electric aircraft battery bay for payload storage.

### BACKGROUND

The burgeoning of electric vertical take-off and landing (eVTOL) aircraft technologies promises an unprecedented forward leap in energy efficiency, cost savings, and the potential of future autonomous and unmanned aircraft. However, the technology of eVTOL aircraft is still lacking in crucial areas of payload transportation systems. This is particularly problematic as it compounds the already daunting challenges to designers and manufacturers developing an electric aircraft for manned and/or unmanned flight in the real world.

### SUMMARY OF DISCLOSURE

In an aspect a method for utilizing an electric aircraft battery bay for payload storage is provided. The method includes removing an unnecessary battery pack from a battery bay of an electric aircraft, wherein removing the battery pack creates a useable storage space within the battery bay; and loading a payload into the battery bay of the electric aircraft.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1A-1C are various views illustrating an exemplary embodiment of the method of utilizing a battery bay of an electric aircraft for payload storage in accordance with one or more embodiments of the present disclosure;

FIGS. 2 is an isometric view illustrating an exemplary embodiment of an electric aircraft in accordance with one or more embodiments of the present disclosure;

FIG. 3A-B are isometric views illustrating exemplary payload securement mechanisms and components thereof;

FIG. 4A-B are isometric views illustrating exemplary payload conveyor mechanisms;

FIG. 5 is a block diagram illustrating an exemplary embodiment of a computer system in accordance with one or more embodiments of the present disclosure.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

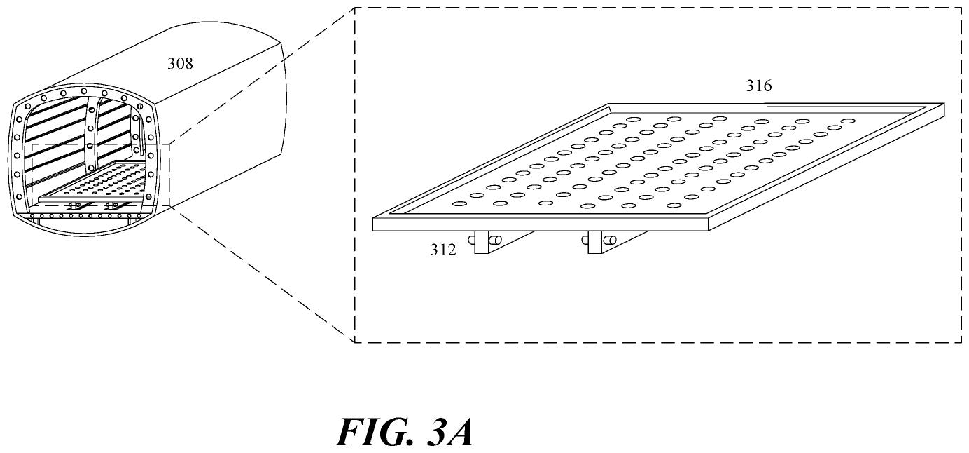

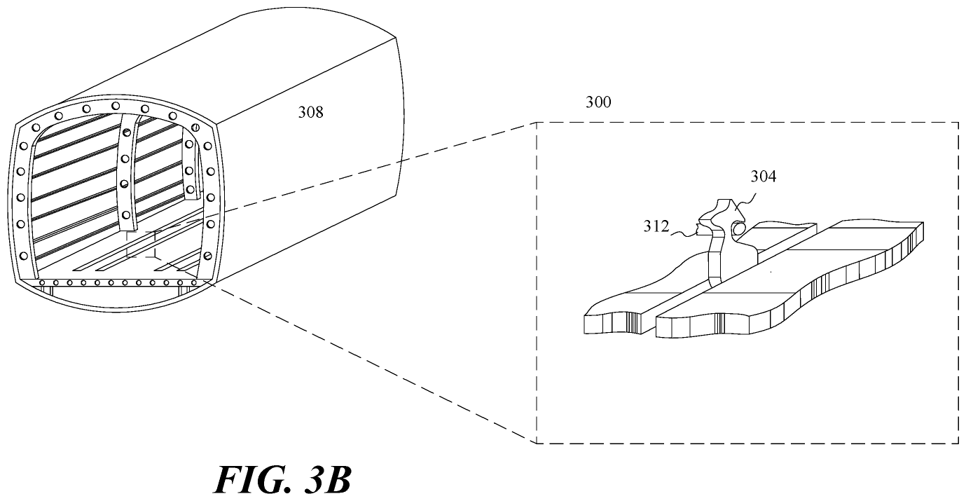

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 3. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

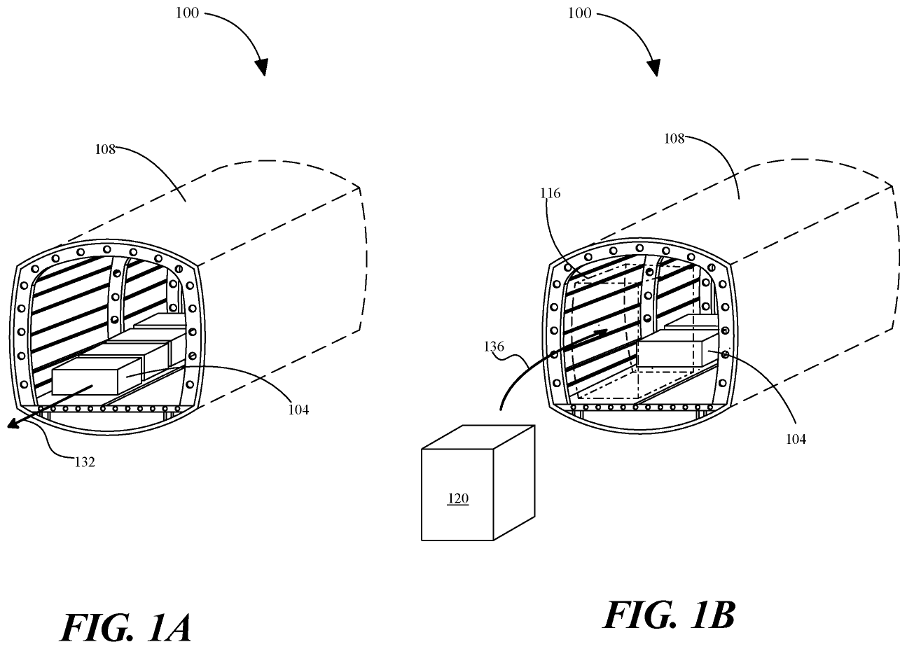

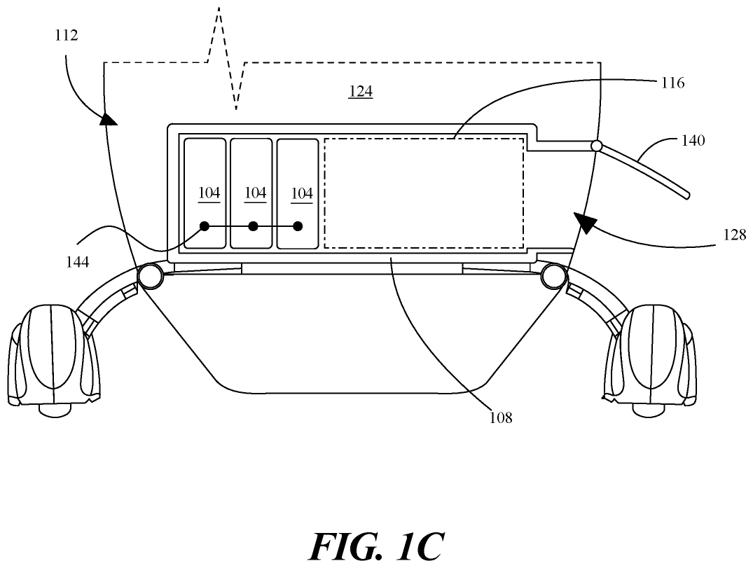

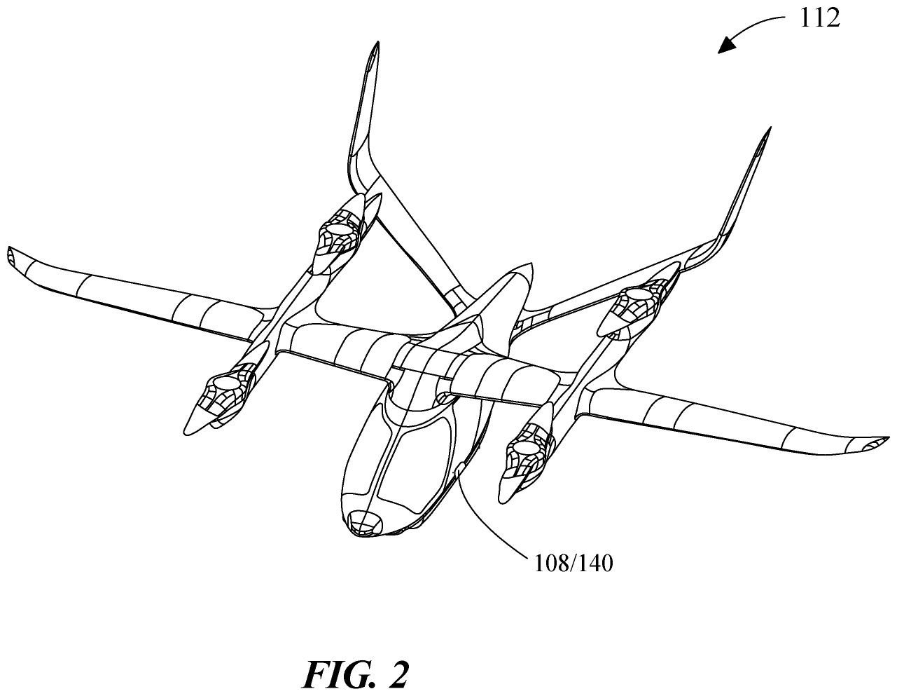

Referring now to FIGS. 1A-1C, an illustration of an exemplary embodiment of a method 100 for utilizing an electric aircraft battery bay for payload storage is shown in accordance with one or more embodiments of the present disclosure. As shown in FIG. 1A, method 100 includes removing, as indicated by directional arrow 132, a battery pack 104 from a battery bay 108 of an electric aircraft 112 (shown in cross-sectional front view FIG. 1C and FIG. 3), where removing battery pack 104 creates a useable storage space 116 within battery bay 108. In an exemplary embodiment, a plurality of unrequired battery packs may be removed from battery pack 108 and any necessary battery packs may remain within battery bay 108. As used in this disclosure, an unrequired battery pack is an energy source that is not needed for the operation of an electric aircraft. For example, and without limitation, an unrequired battery pack maybe a backup battery pack or an extra battery pack. For the purposes of this disclosure, a required battery pack is an energy source that is needed to provide power to an electric aircraft and/or one or more components thereof for proper operation of the electric aircraft. For example, a required battery pack may be needed to provide power to a flight component, engine, or other systems of an electric aircraft during operation, such as flight or taxing, of the electric aircraft. In one or more embodiments, storage space 116 may be created by the removal of battery 104 alongside any remaining batteries, such as required batteries. In one or more embodiments, useable storage space 116 may be defined by one or more interior walls of battery bay 108 of electric aircraft 112, as discussed below in this disclosure, and/or by any remaining battery packs.

In one or more embodiments, battery pack 104 includes a power source configured to store and provide an electrical charging current via a power supply connection. As used in this disclosure, a “battery pack,” or “battery,” is a source of electrical power. As used in this disclosure, an “electrical charging current” is a flow of electrical charge that facilitates an increase in stored electrical energy of an energy storage. In one or more non-limiting embodiments, battery pack 104 may be configured to store a range of electrical energy between approximately 5 KWh and about 5,000 KWh. Battery pack 104 may house a variety of electrical components.

In one or more embodiments, battery pack 104 may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a capacitor and/or inductor. Battery may include, without limitation, Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode. In embodiments, the energy source may be used to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. The battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. A person of ordinary skill in the art, upon reviewing the entirety of this disclosure, will be aware of various devices of components that may be used as an energy source.

In one or more embodiments, battery pack 104 is configured to supply power to electric aircraft 112 and/or subsystems thereof for operation. In one or more embodiments, electric aircraft 112 may include a plurality of battery packs 104. For example, as shown in FIG. 1A, power source 108 may include four battery packs mounted within battery bay 108. In one or more embodiments, battery pack 104 may include a plurality of battery modules. For example, and without limitation, battery pack 104 may include fourteen battery modules. In one or more embodiments, each battery module may include a battery cell. For example, and without limitation, a battery module may include a plurality of battery cells. Battery pack 104 may be configured to store electrical energy in the form of a plurality of battery modules, which themselves include of a plurality of battery cells. These cells may utilize electrochemical cells, galvanic cells, electrolytic cells, fuel cells, flow cells, pouch cells, and/or voltaic cells. In general, an electrochemical cell is a device capable of generating electrical energy from chemical reactions or using electrical energy to cause chemical reactions, this disclosure will focus on the former. Voltaic or galvanic cells are electrochemical cells that generate electric current from chemical reactions, while electrolytic cells generate chemical reactions via electrolysis. In general, the term “battery” is used as a collection of cells connected in series or parallel to each other. A battery cell may, when used in conjunction with other cells, may be electrically connected in series, in parallel or a combination of series and parallel. Series connection includes wiring a first terminal of a first cell to a second terminal of a second cell and further configured to include a single conductive path for electricity to flow while maintaining the same current (measured in Amperes) through any component in the circuit. A battery cell may use the term “wired,” but one of ordinary skill in the art would appreciate that this term is synonymous with “electrically connected,” and that there are many ways to connect electrical elements, like battery cells, together. An example of a connector that does not include wires may be prefabricated terminals of a first gender that mate with a second terminal with a second gender. Battery cells may be wired in parallel. Parallel connection includes wiring a first and second terminal of a first battery cell to a first and second terminal of a second battery cell and further configured to include more than one conductive path for electricity to flow while maintaining the same voltage (measured in Volts) across any component in the circuit. Battery cells may be wired in a series-parallel circuit which combines characteristics of the constituent circuit types to this combination circuit. Battery cells may be electrically connected in a virtually unlimited arrangement which may confer onto the system the electrical advantages associated with that arrangement such as high-voltage applications, high-current applications, or the like. In an exemplary embodiment, and without limitation, battery pack 104 may include 196 battery cells in series and 18 battery cells in parallel. This is, as someone of ordinary skill in the art would appreciate, only an example and battery pack 104 may be configured to have a near limitless arrangement of battery cell configurations.

Configuration of a battery pack containing connected modules may be designed to meet an energy or power requirement and may be designed to fit within a designated footprint in an electric aircraft in which the system may be incorporated. energy source may be used to provide a steady supply of electrical power to a load over the course of a flight by a vehicle or other electric aircraft; the energy source may be capable of providing sufficient power for “cruising” and other relatively low-energy phases of flight. An energy source may be capable of providing electrical power for some higher-power phases of flight as well, particularly when an energy source is at a high state of charge and/or state of voltage, as may be the case for instance during takeoff. An energy source may be capable of providing sufficient electrical power for auxiliary loads including without limitation, lighting, navigation, communications, de-icing, steering or other systems requiring power or energy. An energy source may be capable of providing sufficient power for controlled descent and landing protocols, including, without limitation, hovering descent or runway landing.

In one or more embodiments, battery pack 104 may be in electrical communication with other battery packs 104 and/or electric aircraft 112 via an electrical connection 144 (shown in FIG. 1C). For example, battery pack 104 may provide energy to electric aircraft 112 or components thereof via a power supply connection, as previously mentioned above. For the purposes of this disclosure, a “power supply connection” is an electrical and/or physical communication between a battery pack and electric aircraft 112 that powers electric aircraft 112 and/or electric aircraft subsystems for operation. In one or more embodiments, battery pack 104 may include a plurality of battery modules, which in turn may include a plurality of battery cells. For example, and without limitation, battery pack 104 may include fourteen battery modules. In one or more embodiments, each battery module may include a battery cell. For example, and without limitation, battery module may include a plurality of battery cells. In a non-limiting embodiment, electrical connection 144 may be provided by a connector disposed within interior walls of battery bay 108 that battery pack 104 physical connects thereto using a complementary connector. Electrical connection 144 between battery pack 104 and electric aircraft 112, may be disconnected to remove battery pack 104 from battery bay 108, as discussed further below in this disclosure. Two or more batteries and/or battery packs may be connected using a power bus, including without limitation a ring bus. Additional disclosure related to such connections can be found in U.S. patent application Ser. No. 17/348,240 filed on Jun. 15, 2021, and entitled “A SYSTEM AND METHOD FOR DYNAMIC EXCITATION OF AN ENERGY STORAGE ELEMENT CONFIGURED FOR USE IN AN ELECTRIC AIRCRAFT”, the entirety of which in incorporated herein by reference.

Still referring to FIG. 1, one or more batteries and/or battery packs may include and/or be communicatively connected to a pack monitoring unit and/or a module monitoring unit, for instance and without limitation as described in U.S. application Ser. No. 17/529,583, filed on Nov. 18, 2021 and entitled “PACK MONITORING UNIT FOR AN ELECTRIC AIRCRAFT BATTERY PACK AND METHODS OF USE FOR BATTERY MANAGEMENT” and U.S. application Ser. No. 17/529,447, filed on Nov. 18, 2021 and entitled “MODULE MONITOR UNIT FOR AN ELECTRIC AIRCRAFT BATTERY PACK AND METHODS OF USE.” The entirety of each of U.S. application Ser. No. 17/529,583 and U.S. application Ser. No. 17/529,447 is incorporated by reference herein in its entirety.

In one or more embodiments, battery bay 108 may be a cavity disposed within a fuselage 124 of electric aircraft 112. In one or more embodiments, fuselage 124 may include a carbon fiber composite material. Furthermore, fuselage 124 may include a structural frame component, such as a frame, that at least partially defines battery bay 108. For example, and without limitation, a structural frame component of fuselage 124 may include a metal such as steel, titanium, aluminum, and the like. In other example, and without limitation, the structural frame component of fuselage 124 may include composites, such as a carbon fiber composite.

In one or more embodiments, battery bay 108 may include an opening 128 that allows a cavity of battery bay 108 to be in fluid communication with an external environment of electric aircraft 112. In one or more embodiments, method 100 includes traversing payload 120 through opening 128 so that payload 120 may be stored within battery bay 108. In some embodiments, opening 128 may include a maintenance access. In other embodiments, opening 128 may include a vent opening, which also allows air to circulate within battery bay 108 to cool battery packs used to provide power to electric aircraft 112 during operation of electric aircraft 112. In one or more embodiments opening 128 may be sealed, and thus battery bay 108 may be sealed, using a hatch door 140. Door 140 may be attached to fuselage 124 of electric aircraft 112. Door 140 may be moveably connected to electric aircraft 112 or battery bay 108 by a hinge, track, spring, and the like. Door 140 may be securely locked to prevent unwanted opening of and/or access to battery bay 108.

Still referring to FIGS. 1A-1C, removing battery pack 104 from battery bay 108 of an electric aircraft may include disconnecting an electrical connection 128 between battery pack 104 and electric aircraft 112. For example, and without limitation, disconnecting electrical connection 128 between battery pack 104 and electric aircraft 112 includes disconnecting an unnecessary battery pack from any remaining battery packs. In one or more embodiments, each battery pack 104 maybe be electrically isolated so that removing one battery pack from battery bay 108 does not disrupt the operation and/or electrical connection of other remaining battery packs 104 with electric aircraft 112 or components thereof. In another embodiment, each battery pack 104 may include an electrical connection configured to be readily disconnected from electric aircraft 112 and or remaining battery packs 104 in battery bay 108.

Still referring to FIGS. 1A-1C, method 100 includes loading, as indicated by directional arrow 136, a payload 120 into useable storage space 116 of battery bay 108, as shown in FIG. 1B. In one or more embodiments, loading payload into storage space 116 may include traversing payload 120 through an opening 128 of battery bay 108 and placing payload 120 within useable storage space 116 of battery bay 108. As understood by one skilled in the art, storage space 116 may be an area or a volume of battery bay 108 that is not occupied, such as, for example, by battery pack 104. As understood by one skilled in the art, a “payload” refers to a load and/or cargo from which revenue is derived. In some embodiments, opening 128 may include a maintenance access of battery bay 108. In other embodiments, opening 128 may include a vent opening of battery bay 108. A vent opening may be normally used to allow air circulation through battery bay 108 to adjust a temperature of battery pack 104 as desired.

In one or more embodiments, the process of loading payload 120 into battery bay 108 includes manually lifting payload 120 into usable storage space 116. For example, and without limitation, a handler may lift payload 120 and place payload 120 into storage space 108. In other embodiments, the process of loading payload 120 may include automatedly placing payload 120 into usable storage space 116 via a loading mechanism, as discussed further in this disclosure. In one or more embodiments, a loading mechanism may include pneumatic systems, hydraulic systems, electronic systems, and the like. In one or more embodiments, loading mechanism may include a conveyor belt that is configured to transport payload 120 from an external environment of electric aircraft 112 into battery bay 108. In other embodiments, a conveyor belt may be used to transport payload 120 within battery bay 108. For example, a conveyor mechanism may be used to move payload 120 from one location within storage space 116 to a different location of storage space 116. In a non-limiting embodiment, a conveyor belt may include rollers, tracks, wheels, levers, pulleys, belts, and the like.

In one or more embodiments, the method of utilizing battery bay 108 to store payload 120 may include securing payload within battery bay 108, which is discussed in greater detail below. For example, and without limitation, payload 120 may be fixed relative to electric aircraft 112 so that payload 120 does not shift within battery bay 108. Furthermore, payload 120 may be secured so as to prevent payload 120 from abutting or contacting any remaining battery packs 104 within battery bay 108 during flight so as to avoid damage to payload 120 and/or remaining battery packs 104. In one or more embodiments, securing payload 120 within battery bay 108 may include securing, by a latching mechanism, payload 120 within battery bay 108 to prevent movement of payload 120 within battery bay 108, such as during flight of electric aircraft 112. For example, and without limitation, securing payload 120 within battery bay 108 may include securing, by a fastener, payload 120 in battery bay 108 to prevent movement of payload 120 within battery bay 108. In one or more embodiments a fastener may include a strap, a latch, a customizable compartment, and the like. In one or more embodiments, a first component of the latching mechanism may be disposed on the payload and a second component may be disposed on the fuselage, and wherein the first and second components are configured to mechanically couple the payload to the fuselage. In one or more embodiments, a latching mechanism includes a spring latch, a latch bolt, a deadlatch, a draw latch, a spring bolt lock. In one or more embodiments, a latching mechanism may be actuated manually. In other embodiments, a latching system may be actuated automatedly. For example, and without limitation, a pilot in the cockpit may flip a switch or depress a button to actuate a latching mechanism that secures the payload within the battery bay. In another example, and without limitation, an action may be selected from a graphic user interface menu of a remote device so a user may actuate the latching mechanism to secure the payload. Similarly, the latching mechanism may be released so that the payload maybe removed the battery bay by using such automated methods.

Still referring to FIGS. 1A-1C, payload 120 maybe physically isolated from any remaining battery packs in the battery bay. For example, and without limitation, a divider may be configured to divide payload 120 from remaining battery packs 104 in battery bay 108. Thus, in one or more embodiments, method 100 may also include physically separating, by an adjustable divider, payload 120 from a remaining battery 104 in battery bay 108.

In one or more embodiments, method 100 may include a includes a controller 148. Controller 148 may be used to operate any automated features related to executing method 100. Controller 148 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a smartphone, tablet, laptop, or the like. Controller 148 may include a single computing device operating independently, or may include two or more computing devices operating in concert, in parallel, sequentially or the like; two or more computing devices may be included together in a single computing device or in two or more computing devices. Controller 148 may interface or communicate with one or more additional devices as described below in further detail via a network interface device. Network interface device may be utilized for connecting controller 148 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 148 may include but is not limited to, for example, a computing device or cluster of computing devices in a first location and a second computing device or cluster of computing devices in a second location. Controller 148 may include one or more computing devices dedicated to data storage, security, distribution of traffic for load balancing, and the like. Controller 148 may distribute one or more computing tasks as described below across a plurality of computing devices of computing device, which may operate in parallel, in series, redundantly, or in any other manner used for distribution of tasks or memory between computing devices. Controller 148 may be implemented using a “shared nothing” architecture in which data is cached at the worker, in an embodiment, this may enable scalability of system 100 and/or computing device.

With continued reference to FIGS. 1A-1C, controller 148 may be designed and/or configured to perform any method, method step, or sequence of method steps in any embodiment described in this disclosure, in any order and with any degree of repetition. For instance, controller 148 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 148 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIGS. 1A-1C, electric aircraft 112 may include an input control that allows a user to communicate a desired action to controller 148. Input control may include a button, switch, slider, wheel, pedal, toggle, joystick, touchscreen, and the like. One of ordinary skill in the art, upon reading the entirety of this disclosure would appreciate the variety of input controls that may be present in an electric aircraft consistent with the present disclosure. Additionally, or alternatively, input control may include one or more data sources providing raw data. “Raw data,” for the purposes of this disclosure, is data representative of aircraft information that has not been conditioned, manipulated, or processed in a manner that renders data unrepresentative of aircraft information. Input control may be exterior sensor data, interior sensor data, data retrieved from one or more remotely or onboard computing devices. Input control 108 may include audiovisual data, pilot voice data, biometric data, or a combination thereof. Input control 108 may include information or raw data gathered from one or more sensors, such as gyroscopes, inertial measurement units (IMUs), motion sensors, infrared sensors, a combination thereof, or another sensor or grouping of sensors. Input control may be physically located in the cockpit of electric aircraft 112 or remotely located outside of electric aircraft 112 in another location communicatively connected to at least a portion of electric aircraft 112. “Communicatively connected,” for the purposes of this disclosure, is a process whereby one device, component, or circuit is able to receive data from and/or transmit data to another device, component, or circuit; a communicative connection may be performed by wired or wireless electronic communication, either directly or by way of one or more intervening devices or components. In an embodiment, a communicative connection includes electrically connecting an output of one device, component, or circuit to an input of another device, component, or circuit. Communicative connection may be performed via a bus or other facility for intercommunication between elements of a computing device. Communicative connection may include indirect connections via “wireless” connection, low power wide area network, radio communication, optical communication, magnetic, capacitive, or optical coupling, or the like.

In one or more embodiments, input control may be configured to receive user input. User input may include a physical manipulation of a control like a pilot using a hand and arm to push or pull a lever, or a pilot using a finger to manipulate a switch. Input control may include buttons, switches, or other binary inputs in addition to, or alternatively than digital controls about which a plurality of inputs may be received. In one or more embodiments, user input may include a voice command by a pilot to a microphone and computing system consistent with the entirety of this disclosure. In a non-limiting embodiment, a pilot input may include a pilot depressing a button, which is a control input, in a cockpit of electric aircraft 112. The pilot input may be received by controller 148 via the control input to then execute a desired process of method 100. For example, a pilot depressing a button may result in controller 148 generating a control signal to a component of electric aircraft 112 that converts the electric signal into a mechanical movement, such as automatedly loading payload 120 into battery bay 108 via a loading mechanism, such as a conveyor belt.

Now referring to FIG. 3, an illustration of an exemplary embodiment of electric aircraft 112 with a battery bay 108 is shown in accordance with one or more embodiments of the present disclosure. In one or more embodiments, electric aircraft 112 may be a vertical takeoff and landing aircraft (eVTOL). As used in this disclosure, a vertical take-off and landing (eVTOL) aircraft is one that can hover, take off, and land vertically. An eVTOL, as used in this disclosure, is an electrically powered aircraft typically using an energy source, such as a plurality of battery packs. In order to optimize the power and energy necessary to propel the aircraft, an eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described in this disclosure, is where an aircraft generates lift and propulsion by way of one or more powered rotors coupled with an engine, such as a “quad copter,” multi-rotor helicopter, or other vehicle that maintains its lift primarily using downward thrusting propulsors. Fixed-wing flight, as described in this disclosure, is where the aircraft is capable of flight using wings and/or foils that generate life caused by the aircraft's forward airspeed and the shape of the wings and/or foils, such as airplane-style flight.

With continued reference to FIG. 3, a number of aerodynamic forces may act upon the electric aircraft 112 during flight. Forces acting on an electric aircraft 500 during flight may include, without limitation, thrust, the forward force produced by the rotating element of electric aircraft 112 and acts parallel to the longitudinal axis. Another force acting upon electric aircraft 112 may be, without limitation, drag, which may be defined as a rearward retarding force which is caused by disruption of airflow by any protruding surface of electric aircraft 112 such as, without limitation, the wing, rotor, and fuselage. Drag may oppose thrust and acts rearward parallel to the relative wind. A further force acting upon electric aircraft 112 may include, without limitation, weight, which may include a combined load of the electric aircraft 112 itself, crew, baggage, and/or fuel. Weight may pull electric aircraft 112 downward due to the force of gravity. An additional force acting on electric aircraft 112 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 112 ay be designed to be as lightweight as possible. Reducing the weight of the aircraft and designing to reduce the number of components is essential to optimize the weight. To save energy, it may be useful to reduce weight of components of an electric aircraft 112, including without limitation propulsors and/or propulsion assemblies. In some embodiments, electric aircraft 112 may include at least on vertical propulsor. In an embodiment, electric aircraft 112 may include at least one forward propulsor. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 112 and/or propulsors.

In one or more embodiments, batter bay 108 is disposed within fuselage 124 of electric aircraft 112. For example, and without limitations, battery bay 108 may be disposed in a region above the landing gear of electric aircraft 112 (shown in FIG. 1C). Fuselage 124 of electric aircraft 112 may include structural elements that at least partially define battery bay 108. Structural elements may comprise struts, beams, formers, stringers, longerons, interstitials, ribs, structural skin, doublers, straps, spars, or panels, to name a few. Battery bay 108 may include a plurality of materials, alone or in combination, in its construction. For example, battery bay 108 may include aluminum, titanium, steel, or other metals. In non-limiting embodiments, battery bay 108 may include a welded steel interior walls configured to define a cavity of battery bay 108 that may receive battery pack 104 and/or payload 120. Steel may comprise a plurality of alloyed metals, including but not limited to, a varying amount of manganese, nickel, copper, molybdenum, silicon, and/or aluminum, to name a few. Battery bay 108 may also include materials such as carbon fiber, fiberglass panels, cloth-like materials, aluminum sheeting, or the like, to name a few.

In one or more embodiments, fuselage 124 may include a monocoque or semi-monocoque construction. In one or more embodiments, the internal bracing structure of fuselage 124 need not be present if the aircraft skin provides sufficient structural integrity for aerodynamic force interaction, integral to skin if the preceding is untrue, or integral to aircraft skin itself.

For the purposes of this disclosure, “carbon fiber” may refer to carbon fiber reinforced polymer, carbon fiber reinforced plastic, or carbon fiber reinforced thermoplastic (CFRP, CRP, CFRTP, carbon composite, or just carbon, depending on industry). Carbon fiber, as used herein, is an extremely strong fiber-reinforced plastic which contains carbon fibers. In general, carbon fiber composites consist of two parts, a matrix and a reinforcement. In carbon fiber reinforced plastic, the carbon fiber constitutes the reinforcement, which provides strength. The matrix can include a polymer resin, such as epoxy, to bind reinforcements together. Such reinforcement achieves an increase in CFRP's strength and rigidity, measured by stress and elastic modulus, respectively. In embodiments, carbon fibers themselves can each comprise a diameter between 5-10 micrometers and include a high percentage (i.e. above 85%) of carbon atoms. A person of ordinary skill in the art will appreciate that the advantages of carbon fibers include high stiffness, high tensile strength, low weight, high chemical resistance, high temperature tolerance, and low thermal expansion. According to embodiments, carbon fibers are usually combined with other materials to form a composite, when permeated with plastic resin and baked, carbon fiber reinforced polymer becomes extremely rigid. Rigidity, for the purposes of this disclosure, is analogous to stiffness, and is generally measured using Young's Modulus. Colloquially, rigidity may be defined as the force necessary to bend a material to a given degree. For example, ceramics have high rigidity, which can be visualized by shattering before bending. In embodiments, carbon fibers may additionally, or alternatively, be composited with other materials like graphite to form reinforced carbon-carbon composites, which include high heat tolerances over 2000 degrees Celsius (3632 degrees Fahrenheit). A person of skill in the art will further appreciate that aerospace applications require high-strength, low-weight, high heat resistance materials in a plurality of roles where carbon fiber exceeds such as fuselages, fairings, control surfaces, and structures, among others.

Now referring to FIGS. 3A and 3B, a mechanism for securing payload in battery bay 108 is presented. Battery bay 308 may be similar to, or the same as battery bay 108. Battery bay 308 may be configured to receive a payload pallet 316. Payload pallet 316 may comprise pin 312 disposed in or on it and may be retained within battery bay 308 by payload latch 304. In an illustrative embodiment, payload latch 312 may comprise a hook that engages around pin 312 arresting payload pallet 316 from movement relative to battery bay 308.

Referring to FIG. 3A, payload pallet 316 may be further configured to accept a plurality of payload types. A payload, for the purposes of this disclosure is a part of an aircraft's load, from which revenue is derived, and further, items that the aircraft will move from one place to another that are not the pilot(s). Payload pallet 316 may be configured to load a plurality of cargo types on it. Payload pallet 316 may be reconfigurable such that one pallet may be ready to accept shipping crates for one flight, and at the drop-off location, be reconfigured such that the same pallet can then be adjusted to accept differing payload for the next flight. Additionally, or alternatively, a first payload pallet 316 may comprise hardware for quick removal and be easily replaced with a second payload pallet 316 configured to move the same type of payload or a different type of payload. Payload pallet 316 may comprise hardware one of ordinary skill in the art of freighting would appreciate as commonplace in the shipping of cargo. Payload pallet 316 may comprise tracks, rollers, channels, D-rings, loops, walls, ridges, dividers, or the like, to name a few. Payload pallet 316 may retain cargo on top and within it by a plurality of methods known to one of ordinary skill in the art like ratchet straps, nets, retainment by pallet geometry like cutouts or slots where cargo press fits in, tiedowns, clips, ropes, or hooks, to name a few. Payload pallet 316 may be configured to hold down a plurality of types of cargo including, but not limited to, crates, boxes, oblong or irregular packages, smaller packages, or pallet-specific cargo crates designed to fit payload pallet 316. It is to be noted that payload pallet 316 is not restricted to cargo designed to be shipped or otherwise transported specifically on payload pallet 316 but may accept a plurality of industry-known shipping containers. Payload pallet 316 may comprise multilevel container retainment hardware like shelving, for example. Shelving may be configured to accept small packages on the order of a foot cubed or less, for example. It should be noted that no limitation on container size is attributed to payload pallet other than fitting within storage space of battery bay.

Still referring to FIG. 3A, payload pallet 316, which, as disclosed above, is configurable to accept a plurality of cargo types, may also comprise a latching element 312. Latching element 312, as illustrated in FIG. 3A, may comprise a pin, but alternatively or additionally may comprise a loop, D-ring, slot, channel, opening, hole, or another undisclosed type, to name a few. Latching element 312 may be disposed in or on a surface of payload pallet 316, alone or one amongst a plurality of latching elements 312. Latching element 312 may be disposed evenly or irregularly spaced along a surface or multiple surfaces of payload pallet 316. Latching element 312 may comprise a component mechanically connected to payload pallet 316 or a component integral to payload pallet 316 itself. One or ordinary skill in the art would appreciate that latching element 312 may be disposed in a plurality of locations on payload pallet 316 and may also be oriented in a plurality of directions and comprise a plurality of shapes not necessarily presented in FIGS. 3A and 3B.

Referring now to FIG. 3B, latching mechanism 304 can be seen presented in a breakout view of battery bay 308 within payload fuselage 300. In a non-limiting example, latching mechanism 304 may comprise a hook to capture at least a portion of latching element 312. One of ordinary skill in the art would appreciate that the mechanical shape and properties of one latching element 312 may inform the mechanical shape and properties of latching mechanism 304 that captures at least a portion of it. In other words, and in a non-limiting example, a plurality of latching elements 312 may require a plurality of latching mechanisms 304. This example in no way limits the embodiments the latching mechanism or element may take, and in no way precludes the use of latching mechanism 304 with any one or more of a plurality latching elements 312 and vice versa.

Referring again to FIG. 3B, latching mechanism 304 may be actuated manually or automatedly. Latching mechanism 304 may comprise spring loaded elements that allow for payload pallet 316 to move past it in a first direction, actuate latching mechanism 304 on the way by, and latch on to latching element 312 and hinder movement of payload pallet 316 in a second direction. Latching mechanism 304 may be mechanically actuated to the capture position by a moving payload pallet 316 as previously described or manually by personnel operating electric aircraft or personnel loading payload into battery bay 308. Additionally, or alternatively, latching mechanism 304 may be actuated automatedly by a plurality of methods. In a non-limiting example, a pilot from the cockpit may command latching mechanism 304 to the capture position or the release position electronically through any of the actuation systems disclosed above in this paper like hydraulics, pneumatics, or electromechanical, to name a few. These disclosed actuation systems may drive latching mechanism 304 to a capture position, release position, or any other intermediate or extreme position relative to latching element 312 and battery bay 308.

With continued reference to FIGS. 3A and 3B, latching mechanism 304, latching element 312, payload pallet 316, may comprise suitable materials for high-strength, low-weight applications one of ordinary skill in the art of aircraft manufacture, passenger airlines, airline freighting would appreciate there is a vast plurality of materials suitable for construction of this payload system in an electric aircraft. Some materials used may include aluminum and aluminum alloys, steel and steel alloys, titanium and titanium alloys, carbon fiber, fiberglass, various plastics including acrylonitrile butadiene styrene (ABS), high-density polyethylene (HDPE), and even wood, to name a few.

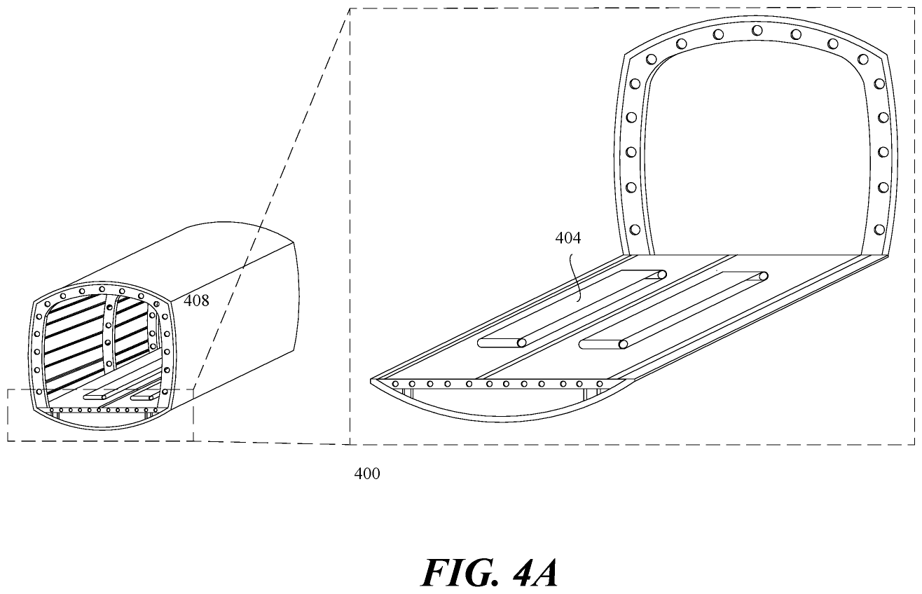

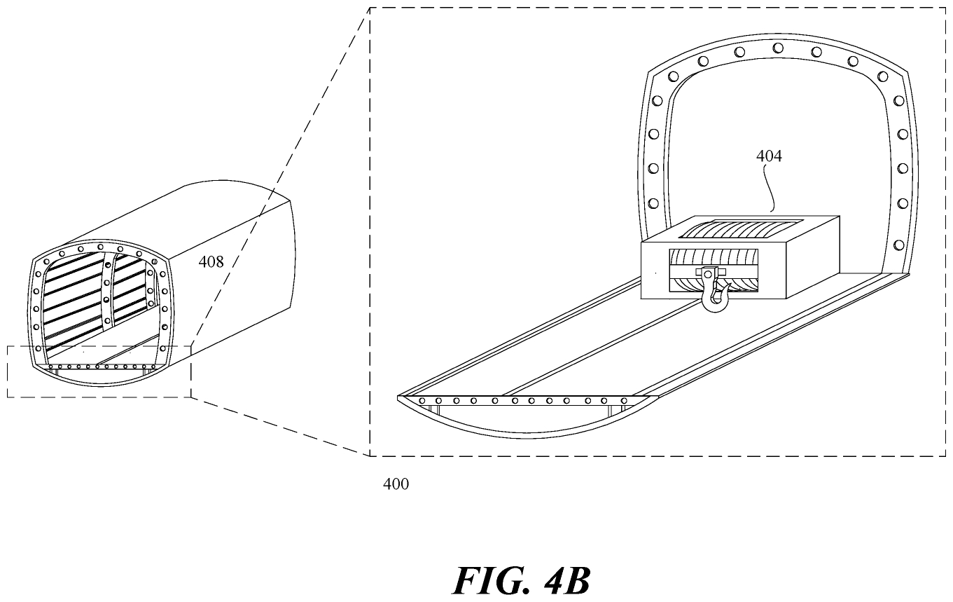

Referring now to FIGS. 4A and 4B, a conveyor system 400 is presented. Conveyor system 400 may comprise conveyor mechanism 404 and be housed, at least in part, by battery bay 408. Conveyor mechanism 404 may be configured to assist personnel, other transportation equipment, or otherwise transport a payload into battery bay 408 for storage. Conveyor mechanism 404 may be further configured to be manually or automated activated to pull, push, roll, or otherwise move cargo from an exterior of electric aircraft 112 to storage space 116. In one or more embodiments, conveyor mechanism 404, in an exemplary embodiment, may be fully contained within battery bay 408, so personnel, whether manually or using cargo vehicles, need only to place payload at the opening of battery bay 408, where conveyor mechanism may then do the work required to move payload 120 into its flight position within storage space 116. Additionally, or alternatively, conveyor mechanism 404 may be only partially enclosed by battery bay 408. In this exemplary embodiment, conveyor mechanism 404 may manually or automatedly extend out past battery bay 408 such that a payload can be retracted into battery bay 408 from a distance. In yet another non-limiting example, conveyor mechanism 404 may be configurable to be either totally, partially, or not enclosed at all by battery bay 408. Pilots, personnel, or controllers may command conveyor mechanism, in an embodiment, to extend out of battery bay 408, receive a payload in some way, perhaps similarly to the embodiment presented in FIGS. 4A and 4B, and retract payload into final storage position.

Conveyor mechanism 404 may comprise a plurality of mechanisms including but not limited to conveyor belts, hooks, winches, rollers, wheels, balls, slots, channels, among others, to name a few. Referring to FIG. 4A, conveyor mechanism 404 is presented as a conveyor belt type mechanism, but this in no way limits the technologies this mechanism can take. Conveyor mechanism 404 may comprise provisions for securing payload during the translation or moving process. These provisions may be the same, similar, or different than systems disclosed in the entirety of this paper. Conveyor mechanism 404 may be activated and further operated manually or automatedly. A pilot may control conveyor system 400 through the entirety of its operation, such as via controller 148. Activation of system may comprise the extension of conveyor mechanism 404 out of battery bay 408 after door 140 to battery bay 108 is opened and one or more battery packs 104 are removed from battery bay 108. Alternatively, personnel handling the loading of cargo into battery bay 408 through conveyor mechanism 404 may interface with electromechanical controls, such as a control input, disposed on or in portion of electric aircraft 112, or separately disposed but wirelessly connected to electric aircraft 112. Conveyor system 400 does not necessarily require a powered control system, and may comprise physical interfaces like levers, ropes, pulleys, handles, among others, to name a few. These manual interfaces may allow personnel to pull a conveyor mechanism 404 out of battery bay 408 to place a payload in position in or on it.

Conveyor mechanism 404 may be configured to move payloads in a plurality of directions and orientations. For example, and without limitations, conveyor mechanism 404 may be bidirectional, where a payload may only move in two directions, “in” and “out” of battery bay 408. An illustrative embodiment may comprise a conveyor belt stored in the floor of battery bay 408, where a conveyor belt may then be actuated to extend out of the fuselage, a payload can be placed on and secured to conveyor belt, where then the conveyor belt pulls payload into battery bay 408 and retracts back into floor of battery bay 408. Additionally, or alternatively, conveyor mechanism 404 can move payloads in a plurality of directions. In an exemplary embodiment, rollers disposed on or in the floor of battery bay 408 may comprise spheres which extend up past floor so only a hemisphere is exposed. A payload could be rolled onto the spheres, where a combination of powered rolling spheres could move payload in any direction in a plane parallel to floor of battery bay 408. This is merely a non-limiting example, and in no way precludes other instances a conveyor mechanism 404 can take.

Conveyor mechanism 404 may be a combination of two or more machines that can retain a payload and retract or move that payload into its storage position within battery bay 408. For example, a conveyor mechanism 404 may comprise a conveyor belt, comprising a flexible belt around two or more powered rollers, that when activated, spin, that in turn rotate conveyor belt about rollers. The rollers may be mechanically coupled to linkages that can, when actuated, change direction, length, angle, or shape of conveyor belt. In a specific embodiment, these linkages may be extended such that a payload can be pulled from a low point, diagonally upward to a higher point in battery bay 408. Additionally, linkages attached to rollers may actuate non-symmetrically to extend a conveyor diagonally in the same plane as battery bay 408 floor.

Conveyor system 400, as disclosed above, may transport payloads in three dimensions during the loading phase. Conveyor system 400 may comprise, in a non-limiting example, conveyor mechanism 404 in the form of a scissor lift, elevator, or lift. Conveyor mechanism 404 may extend out of battery bay 408 a certain length, and a second actuation could lower lift from battery bay level to loading level and bring payload to battery bay level after loading.

With continued reference to FIGS. 4A and 4B, conveyor system 400, conveyor mechanism 404, battery bay 408 may include suitable materials for high-strength, low-weight applications one of ordinary skill in the art of aircraft manufacture, passenger airlines, airline freighting would appreciate there is a vast plurality of materials suitable for construction of this payload system in an eVTOL aircraft. Some materials used may include aluminum and aluminum alloys, steel and steel alloys, titanium and titanium alloys, carbon fiber, fiberglass, various plastics including acrylonitrile butadiene styrene (ABS), high-density polyethylene (HDPE), and even wood, to name a few.

Sensors of plurality of sensors may be designed to measure a plurality of electrical parameters or environmental data in-flight, for instance as described above. Plurality of sensors may, as a non-limiting example, include a voltage sensor designed and configured to measure the voltage of at least an energy source. As an example, and without limitation, the plurality of sensors may include a current sensor designed and configured to measure the current of at least an energy source. As a further example and without limitation, the plurality of sensors may include a temperature sensor designed and configured to measure the temperature of at least an energy source. As another non-limiting example, the plurality of sensors may include a resistance sensor designed and configured to measure the resistance of at least an energy source. The plurality of sensors may include at least an environmental sensor. In an embodiment, environmental sensor may sense one or more environmental conditions or parameters outside the electric aircraft, inside the electric aircraft, or within or at any component thereof, including without limitation at least an energy source, at least a propulsor, or the like; environmental sensor may include, without limitation, a temperature sensor, a barometric pressure sensor, an air velocity sensor, one or more motion sensors which may include gyroscopes, accelerometers, and/or a inertial measurement unit (IMU), a magnetic sensor, humidity sensor, an oxygen sensor and/or a wind speed sensor. At least a sensor may include at least a geospatial sensor. As used herein, a geospatial sensor may include without limitation optical devices, radar devices, Lidar devices, and/or Global Positioning System (GPS) devices, and may be used to detect aircraft location, aircraft speed, aircraft altitude and/or whether the aircraft is on the correct location of the flight plan. Environmental sensor may be designed and configured to measure geospatial data to determine the location and altitude of the electronically powered aircraft by any location method including, without limitation, GPS, optical, satellite, lidar, radar. Environmental sensor may be designed and configured to measure at a least a parameter of the motor. Environmental sensor may be designed and configured to measure at a least a parameter of the propulsor. Environmental sensor may be configured to measure conditions external to the electrical aircraft such as, without limitation, humidity, altitude, barometric pressure, temperature, noise and/or vibration. Sensor datum collected in flight may be transmitted to the aircraft controller or to a remote device, which may be any device. As an example, and without limitation, remote device may be used to compare the at least an electrical parameter to the at least a current allocation threshold and/or detect that the at least an electrical parameter has reached the current allocation threshold.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

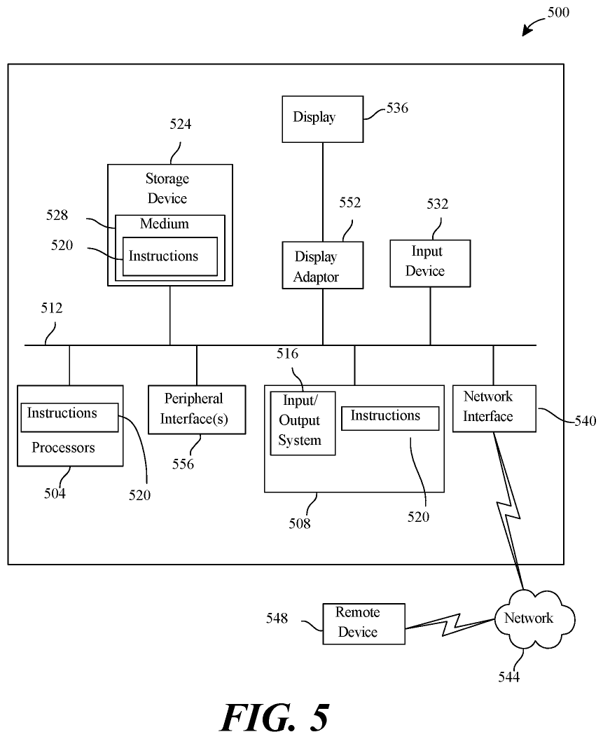

FIG. 5 shows a diagrammatic representation of one embodiment of a computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems and methods as described above. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method for utilizing an electric aircraft battery bay for payload storage, the method comprising:
receiving battery data from a plurality of battery sensors at a first input control, wherein the plurality of battery sensors are communicatively connected to a plurality of battery packs;
generating, at a controller of the electric aircraft, a first control signal as a function of the battery data;
communicating the control signal from the controller to a conveyer mechanism of the battery bay, wherein the conveyer mechanism further comprises a hook and powered-spheres disposed on the floor of the battery bay which extend up past the floor so only a hemisphere is exposed;
ejecting, using the powered spheres, the battery pack from the battery bay of the electric aircraft as a function of the control signal, wherein ejecting the battery pack creates a useable storage space within the battery bay, and wherein ejecting the battery pack further comprises:
disconnecting an electrical connection between the battery pack and the electric aircraft
receiving pilot input at a second input control of the electric aircraft;
generating, at the controller of the electric aircraft, a second control signal as a function of the pilot input;
communicating the control signal from the controller to the conveyer mechanism of the battery bay;
automatedly extending the hook from the conveyer mechanism, wherein extending the hook further comprises attaching the hook to a payload; and
loading a payload into the useable storage space of the battery bay with the hook as a function of the second control signal.

2. The method of claim 1, wherein the battery bay is disposed within a fuselage of the electric aircraft.

3. The method of claim 2, wherein the fuselage comprises a carbon fiber composite material.

4. The method of claim 2, wherein the fuselage comprises a structural frame component.

5. The method of claim 4, wherein the structural frame component comprises aluminum.

6. (canceled)

7. (canceled)

8. (canceled)

9. (canceled)

10. (canceled)

11. The method of claim 1, wherein the spheres can contract into the floor of the battery bay.

12. (canceled)

13. The method of claim 1, wherein loading the payload into the battery bay comprises traversing the payload through a maintenance access of the battery bay.

14. The method of claim 1, wherein loading the payload into the battery bay comprises traversing the payload through a vent opening of the battery bay.

15. The method of claim 1, further comprising securing, by a fastener, the payload in the battery bay to prevent movement of the payload within the battery bay.

16. The method of claim 1, further comprising securing, by a latching mechanism, the payload within the battery bay to prevent movement of the payload within the battery bay.

17. The method of claim 16, wherein a first component of the latching mechanism is disposed on the payload and a second component is disposed on the fuselage, and wherein the first and second components are configured to mechanically couple the payload to the fuselage.

18. The method of claim 16, wherein the latching mechanism comprises a spring latch.

19. The method of claim 1, further comprising physically separating, by an adjustable divider, the payload from a necessary battery pack remaining in the battery bay.

20. The method of claim 1, further comprising sealing the battery bay with a hatch door.
